(19) United States
(12) Patent Application Publication
(10) Pub. No.: US 2011/0232676 A1
(43) Pub. Date: Sep. 29, 2011

(54) Dental floss device

(76) Inventors: Efin Rubens, Brooklyn, NY (US); Karl Bikhman, Brooklyn, NY (US)

(21) Appl. No.: 12/661,983

(22) Filed: Mar. 29, 2010

(51) Int. Cl. A61C 15/04

(52) U.S. Cl. 132/325

(57) ABSTRACT

A dental floss devise comprises two separate rods connected to a length of dental floss. The device may include tooth picking and gum massaging capabilities along with a flossing capability which capabilities may be utilized simultaneously. The device may be disposable. The device may also be multi-use, which provides for attachment of a piece of dental floss cut from a roll to separate rods. In some embodiments of the invention the rods may be equipped with comfortable handles.

### FIELD OF INVENTION

The Dental Floss Device generally relates to dental cleaning, more specifically dental flossing. The Device is designed to simplify the process of flossing and to make it more efficient.

### BACKGROUND OF THE INVENTION

The three general methods of cleaning teeth utilizing dental floss (or, “flossing”) are: (1) A length of dental floss is cut from a roll, held in both hands by its ends and manipulated to clean the teeth; (2) A lengths of floss is stretched between two prongs of a c-shaped plastic frame with a handle which allows it to be manipulated by a single hand while cleaning teeth; and (3) a length of dental floss is attached to two handles of various shape which would allow for a more comfortable holding and operation of the floss.

The disadvantage of the first method is the necessity to place fingers inside one's mouth, which could introduce more germs from the fingers into one's mouth. Secondly, the cleaning is uncomfortable and deficient due to inability to fully reach back teeth. Finally, the first method causes the waste of floss.

The disadvantage of the second method is the constant tension applied to the length of dental floss, which does not permit effective cleaning around teeth, as well as, the inability to place the c-shaped frame in optimal position for flossing.

As to the third method, there is a number of patented devices utilizing two holder portions, sometimes even rod-like, connected by a piece of dental floss which did not find any substantial use in practice. The reason is that the devices proposed, for instance those disclosed in U.S. Pat. No. 4,342,324, U.S. Pat. No. 4,403,625, U.S. Pat. No. 5,174,314, and U.S. Pat. No. 5,911,229 have been designed in a manner that would neither produce a desired effect that is claimed in those patents, nor would be feasible in terms of production costs.

The present invention overcomes the disadvantages of the above methods by eliminating the necessity of placing finger into one's mouth, but, at the same time, by improving the ability to maneuver and to manipulate the floss, and allowing the application of the variable tension to a length of floss, which would allow effective cleaning. Moreover, the ability to manufacture the device very cheaply by injection-molding the rods together with the dental floss in one step makes the device economically feasible to produce.

### SUMMARY

According to the invention, a small length of dental floss, measuring between 0.5 and 1.5 inch is attached by its ends to one of the ends of two separate rods. For the ease of understanding we chose to designate the ends of the rods to which the dental floss attaches as top ends, and the opposite ends of the rods as bottom ends. These rods shall measure not less than 2 inches in length. These rods will be easily manipulated inside the mouth by both hands, but without the need to place fingers into one's mouth. Variable tension may be applied to the length of floss as required for effective cleaning. Moreover, due to the fact that the ends of the rods may come very close to the teeth in any position in reference to one another, the floss is allowed to better loop around the tooth, to follow the curvature of the tooth, which causes it to better clean the tooth. In another embodiment of the invention, the device has a capability to utilize dental floss from a roll by quickly attaching the ends of a length of dental floss cut from a roll to two separate rods. In another embodiment of the invention the flossing is combined with tooth picking and (gum massaging) in the same operation.

### DESCRIPTION OF THE DRAWINGS

FIG. 1 is a view showing the two rods connected by a length of dental floss, which illustrates the preferred embodiment of the invention;

FIG. 2 is a view showing the two rods connected by a length of dental floss, the opposite ends of the rods are equipped with handles;

FIG. 3 is a view of two rods connected by a length of dental floss allowing combination flossing and tooth picking;

FIG. 4 is a view of two rods connected by a length of dental floss allowing improved tooth picking in conjunction with flossing;

FIG. 5 is a view of another version of two rods connected by a length of dental floss allowing improved tooth picking and gum massaging in conjunction with flossing;

FIG. 6 is a view of another version of two rods connected by a length of dental floss allowing improved tooth picking and improved gum massaging in conjunction with flossing;

FIG. 7 is view of another version of two rods allowing the use of dental floss from a roll; and

FIG. 8 is an enlarged view along the arrow A of FIG. 7;

FIG. 9 is a view of a second version of the rod allowing the use of dental floss from a roll;

FIG. 10 is a view of a third version of the rod allowing the use of dental floss from a roll;

FIG. 11 is a view of rod with an attached roll of dental floss;

### DETAILED DESCRIPTION

Referring to the FIG. 1 of the drawings, there is illustrated a dental floss device according to the invention comprising a length of dental floss 1, the ends of which are connected to one of the ends of each separate rod 2. The ends to which dental floss connects we called the top end in our claims for the ease of understanding. The opposite end is called a bottom end for the same purpose. Rod is an elongated member of any shape known to men today or later invented, and may have specific shape for ease of use by blind people. Dental floss is either a thin nylon filament or a plastic (such as Teflon or polyethylene) ribbon used to remove food and dental plaque from teeth. The floss is gently inserted between the teeth and scraped along the teeth sides, especially close to the gums. Dental floss may be flavored or unflavored, and waxed or unwaxed. The length of the rods shall be not less than 1.5 inches. The length of dental floss shall be between 0.5 and 1.5 inches and shall be set to allow for comfortable manipulation of the floss inside the mouth by allowing for variable tension applied to the length of floss 1, and for comfortable insertion between the teeth. There is a lock 3 provided on one of the rods to connect the rods together for ease of storage.

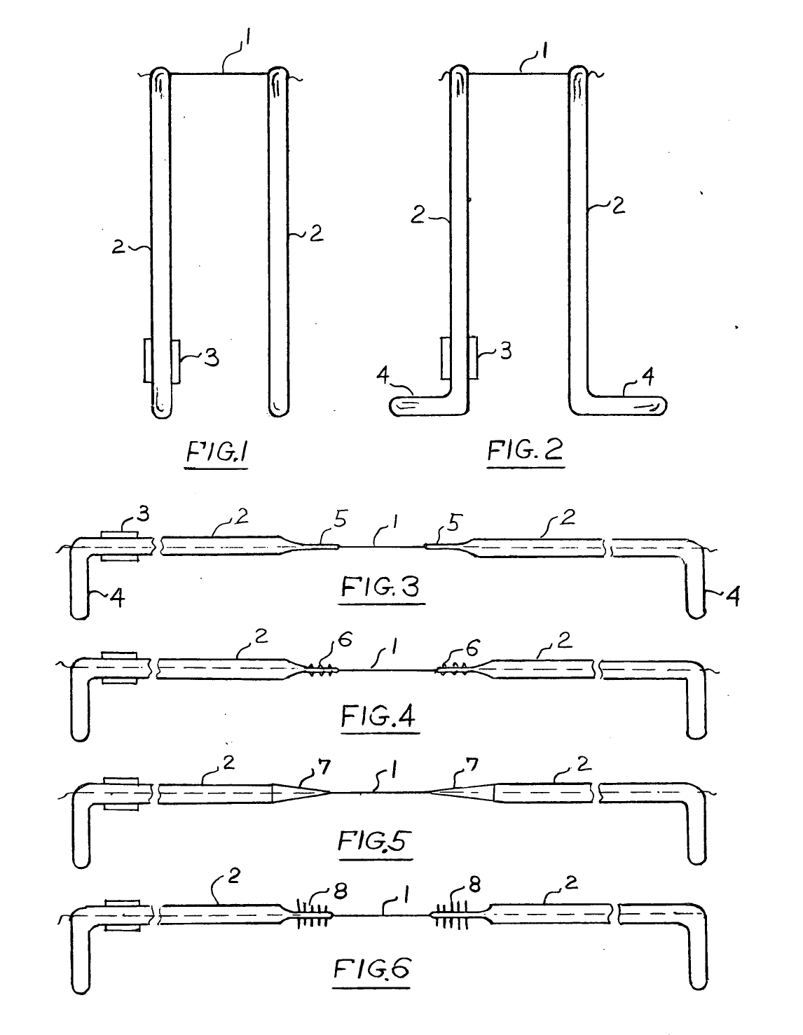

Referring to FIG. 2 of the drawings, there is illustrated a dental floss device comprising of rods with handles 4 located on the bottom rod ends opposite to the top ends of the rods 2 to which the length of dental floss 1 is attached. The handles 4 are added to improve the device manipulation.

Referring to the FIG. 3 of the drawings, there is illustrated a dental floss device according to the invention wherein the top ends 5 of the rods 2 are gradually tapered to a very small point, which points are flexible and are connected by the length of dental floss 1, wherefore allowing tooth picking in conjunction with flossing. The tapered top ends 5 work as toothpicks during flossing. A toothpick is a small stick of used to remove food particles from the teeth, usually after a meal.

Referring to FIG. 4 of the drawings, there is illustrated a dental floss device according to the invention wherein the flexible top ends 6 of the rods 2 connecting to the ends of the length of dental floss 1 are gradually tapered to a very small point and have serrated surface wherefore allowing improved tooth picking in conjunction with flossing.

Referring to FIG. 5 of the drawings, there is illustrated a dental floss device according to the invention wherein the flexible top ends 7 of the rods 2 connecting to the ends of the length of dental floss 1 are gradually tapered to a very small point and are made from soft, flexible material with either smooth or serrated surface wherefore allowing improved tooth picking and gum massaging in conjunction with flossing.

Referring to FIG. 6 of the drawings, there is illustrated a dental floss device according to the invention wherein the flexible top ends 8 of the rods 2 connecting to the ends of the length of dental floss 1 are gradually tapered to a very small point and are made from soft, flexible material with protruding bristles wherefore allowing improved tooth picking and gum massaging in conjunction with flossing.

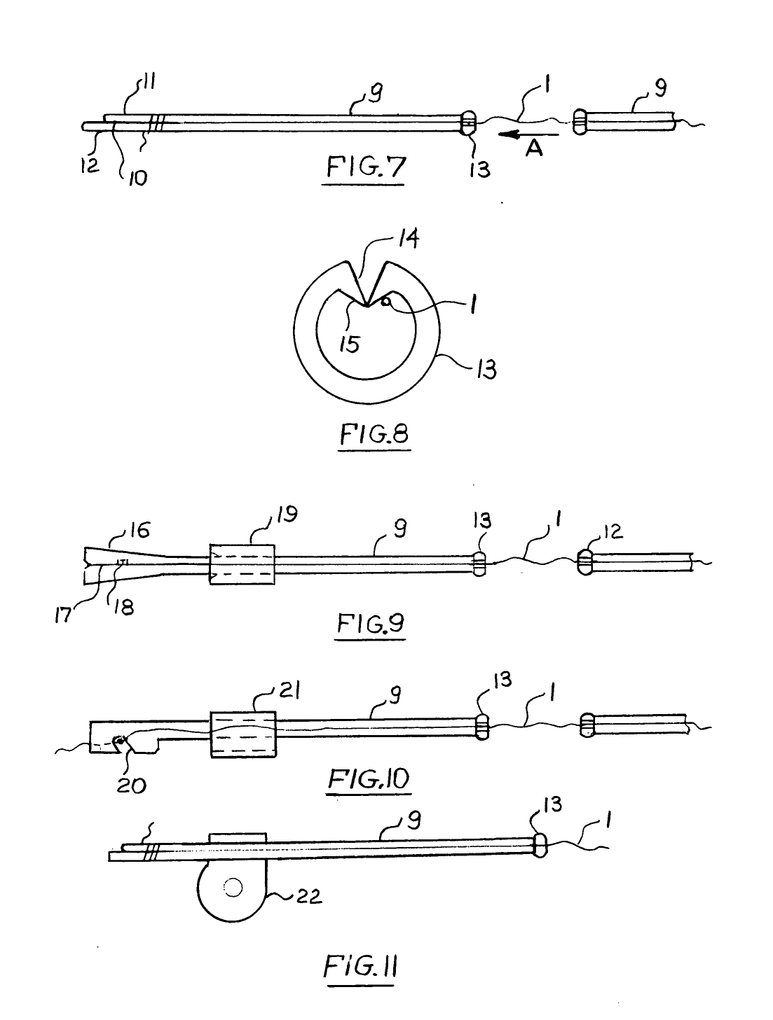

In all dental floss devices illustrated on FIGS. 3 to 6 the rods may be made with the handles 4 or without the handles. Handles may be made of various shape and size known now or to be invented in the future. An alternative embodiment of the invention is illustrated on FIGS. 7 to 10.

Referring to FIG. 7 of the drawings, there are illustrated rods 9 which may be used in conjunction with dental floss from a dental floss roll. The bottom ends of the rods 9 has a split 10 with the two halves of the split 11 & 12 immediately adjacent to one another and touching. One of the halves 12 is slightly longer than the other for the ease of the insertion of the floss. The ends of the length of dental floss 1 are inserted into the split 10 of the said rods and are wound a few times around each rod, this operation is repeated a few times. This part is designed to fasten the end of the dental floss securely in place and attached to one of the ends of each rod.

Referring to FIG. 8 of the drawings, there is illustrated part 13 located on the top ends of the rods 9. This part 13 is a hollowed top end of the rod 9 with a tapered through cut 14 in its wall. The walls of the cut protruding inside the hollowed top end as two touching wedges 15 creating a single wedge, and designed to trap dental floss when inserted into the cut and securing the inserted dental floss to the ends of said rods. This part of the device, in conjunction with the split 10 illustrated on FIG. 7, is designed to prevent the escape of dental floss from the top end of the rod 9. The wedges 15 are holding the floss inside the hollowed end by deflecting the floss away from the cut 14.

Referring to FIG. 9 of the drawings there is illustrated rod 9 with a flared bottom end 16, which has a split 17 and a floss stop 18, which prevents the floss from reaching the end of the split 17. There is a slide 19 sliding along the rod 9. Moving the slide 19 onto the flared end 16 traps the end of the dental floss inserted into the split 17 by squeezing the halves of the split 17 together.

Referring to FIG. 10 of the drawing there is illustrated rod 9 with a cross cut 20 in its body and a slide 21 sliding along the rod 9. When the end of dental floss 1 is inserted into the cross cut 20 and the slide is moved over the cut 20, the floss inserted into the cut is trapped when it is bent and squeezed between the slide and the rod.

Referring to FIG. 11 of the drawing there is illustrated a rod 9 attached to a roll of dental floss 22. The roll of floss 22 may be attached to either one of the two rods 9. The floss is extracted from the roll and is attached to the rods 9 as illustrated on FIGS. 7-10. Any rod type illustrated in FIGS. 7-10 may be used with a roll of dental floss.

In all dental floss devices illustrated on FIGS. 3 to 6 the flexible top ends of the rods may be manufactured from the same material as the rods, or from a different material.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A dental floss device comprising of two separate rods with two ends, a top end and a bottom end; with a length of dental floss, measuring not more than 1.5 inch and not less than 0.5 inch in length, attached by its ends to top ends of each rod; which rods are measuring not less than 1.5 inches in length.

2. The dental floss device according to claim 1 wherein the bottom ends of the rods are equipped with comfortable handles wherefore allowing for more comfortable manipulation of the said rods inside the mouth.

3. A dental floss device comprising of two separate rods with a short length of dental floss connecting the top ends of the rods, measuring not more than 1.5 inch and not less than 0.5 inch in length, attached by its ends to top end each rod wherein the said top ends of the said rods are gradually tapered to a very small point and are flexible wherefore allowing tooth picking in conjunction with flossing.

4. The dental floss device according to claim 3 wherein the said top ends of the said rods connecting to the said flexible ends of the said length of dental floss are gradually tapered to a very small point and have serrated surface wherefore allowing improved tooth picking in conjunction with flossing.

5. The dental floss device according to claim 3 wherein the said top ends of the said rods connecting to the said flexible ends of the said length of dental floss are gradually tapered to a very small point and are made from soft, flexible material with serrated surface wherefore allowing improved tooth picking and gum massaging in conjunction with flossing.

6. The dental floss device according to claim 3 wherein the said top ends of the said rods connecting to the said flexible ends of the said length of dental floss are gradually tapered to a very small point and are made from soft, flexible material with protruding bristles wherefore allowing improved tooth picking and gum massaging in conjunction with flossing.

7. A dental floss device comprising a length of dental floss cut from a roll of dental floss and attached by its ends to two separate rods; the bottom ends of said rods equipped with a floss clamp; the top ends of the rods are hollowed with the wall of that hollowed end cut in one place; the said cut having a tapered shape, the walls of the cut protruding inside the hollowed end as two touching wedges, creating a single wedge and trapping dental floss when inserted into the cut and securing the inserted dental floss to the top ends of said rods by deflecting the floss from the opening through which it was inserted.

8. The dental floss device according to claim 7 wherein the said floss clamp is the end of the rod which is split in half with the two halves of the split immediately adjacent to one another and touching; the ends of the length of dental floss are inserted into the split ends of the said rods and are wound around each rod, this operation is repeated a few times.

9. The dental floss device according to claim 7 wherein the said floss clamp is a flared end of the rod which is split in half, and there is a slide, sliding over that split end and clamping the floss by pressing the two ends of the split end together.

10. The dental floss device according to claim 7 wherein the said floss clamp is an end of the rod with a cross cut and a slide sliding along the rod, which clamps, by bending and squeezing, dental floss inserted into the cross cut when the slide is moved over the cut.

11. The dental floss device according to claim 7 wherein a roll of dental floss is attached to one of the said rods;
